(19) United States
(12) Patent Application Publication
(10) Pub. No.: US 2014/0040479 A1
(43) Pub. Date: Feb. 6, 2014

(54) METHOD FOR A SELF ORGANIZING LOAD BALANCE IN A CLOUD FILE SERVER NETWORK

(71) Applicant: Paul Steven Dunn, Melbourne (AU)

(72) Inventor: Paul Steven Dunn, Melbourne (AU)

(21) Appl. No.: 13/945,994

(22) Filed: Jul. 19, 2013

Related U.S. Application Data
(60) Provisional application No. 61/673,806, filed on Jul. 20, 2012.

(51) Int. Cl. H04L 12/803

(52) U.S. Cl. CPC H04L 47/125
USPC 709/226

(57) ABSTRACT

The present invention relates to a method for improving load balancing and management for file servers in a cloud network. More particularly, this invention relates to a de-centralized file server network which does not require a main central load balancer. The present invention relates to a methodology that results in a self governing network of file servers that create and destroy themselves, modeling similar biological processes.

### CROSS REFERENCE TO RELATED APPLICATION

This applications claims the benefit of and takes priority from U.S. Provisional Patent Application Ser. No. 61/673,806 filed on Jul. 20, 2012, the contents of which are herein incorporated by reference.

### TECHNICAL FIELD

The present invention relates to a method for improving load balancing and management for file servers in a cloud network.

### BACKGROUND INFORMATION

Any references to methods, apparatus or documents of the prior art are not to be taken as constituting any evidence or admission that they formed, or form part of the common general knowledge in any country in the world.

Cloud Server Networks are based on the concept of virtualization. With virtualization an operating system can be become hardware independent, i.e. the physical location of the software is no longer bound to a particular hardware locality. Virtualization technology provides portability, where the Operating System can be moved from one physical machine to another one. This technology can be seen in offerings such as the Amazon Cloud (http://aws.amazon.com/ec2/), Rackspace (http://www.rackspace.com/) or Microsoft Azure (http://www.windowsazure.com/). Such services allow for on-demand allocation of additional resources, such as file-servers and web-servers. They accomplish this by creating a virtualization of these entities running on their own hardware infrastructure. This allows for virtualizations of file-servers to be created and destroyed on demand.

As the internet becomes more important, the necessity of efficient data storage and retrieval grows. A common challenge to high-volume, high-transaction websites is managing the load of these requests and storing the associated data efficiently so as not to overload any particular instance (file-server), thereby degrading the performance of any application relying upon these filer-servers. This task is commonly handled by a technology called Load-Balancers.

Load-Balancing technology distributes workload across multiple file-servers to achieve optimal resource utilization and minimize response time. Traditional Load-Balancers receive external client petitions through their listening port and forward requests to one of the backend servers, which then replies to the load balancer.

This system server architecture involves either purchasing hardware or outsourcing this to a third party to manage and maintain this requirement. In contrast, Cloud Server Networks provide a hardware independent solution that provides virtual machines on demand.

Cloud Networks can handle TCP/IP requests without the need for centralized petitions on a single server.

It is an object of the present invention to provide an improved method for the operation of a Load-Balancer within the context of Cloud Networking or at least a useful alternative to those solutions hitherto known in the prior art.

### SUMMARY OF THE INVENTION

Preferred embodiments of the invention described here, provide a method for a self-organized and self-managed File Server network, e.g. a cloud network.

Each node on the cloud network may be viewed as a contiguous memory stream. There are three main different functionalities in this memory stream.

Data storage is an important function of the cloud network. Preferably each file that has been processed and is ready to be stored will be resident in internet-exposed Main Storage.

In a preferred embodiment of the invention, when data is received by the file server, it will be processed and converted for later storage. Preferably an area inside the File Server is provided that is used to perform these post-processing tasks. Said area constitutes the File Server Post Processing Area and should preferably be set to a small percentage of the total File Server's capacity.

In a preferred embodiment of the invention all file servers will also have a memory area dedicated to a resident management program that is preferably responsible for the File Server. The resident management program is preferably running continuously throughout the life of the File Server.

In a preferred embodiment of the invention, based on a set of constants that must be preconfigured, this resident program, which will be called henceforth “Daemon”, is preferably programmed to analyze the File Server status and take decisions to achieve the goal of bringing itself closer to an equilibrium point. This is an indicator of efficiency in the File Server network.

Preferably each File Server is of a type that has the capacity to create a new File Server as a child, or to destroy itself. This feature removes the need for a centralized Load-Balancer Management routine.

Accordingly, embodiments of the present invention provide a self organizing network where each node will take decisions to try to reach the best performance as defined by an equilibrium point. This creates a scenario in which all applications reliant upon this architecture receive the benefit of this increased efficiency and the drive towards optimal disk space reduces operational costs.

According to a first aspect of the present invention there is provided a method for balancing file server load across a plurality of file servers interconnected by an electronic data network, said file servers each being virtualization capable, the method comprising the steps of, for each of said file servers:

operating a program resident on the file server to determine performance indicators of the file server, including central processing unit load and available storage capacity;

comparing performance indicators of the file server with predetermined file server capacity parameters; and

based on results of the comparison, destroying said file server or creating a child file server to thereby cull superfluous file servers or provide additional file serving capacity respectively.

Preferably said resident program determines performance indicators of its file server, a parent of its file server and one or more child file servers of its file server at predetermined intervals.

Preferably a duration of the predetermined intervals is selected so that it is not too short to degrade performance of the file server and not too long to render the method ineffective.

Preferably the predetermined file server capacity parameters are stored in a data source accessible to the file servers via the electronic data network.

For example, the file server capacity parameters may include one or more of:

a CPU load parameter;

a file lock time parameter,

a poll cycle parameter, which stores a value for the duration of the predetermined intervals; and

a capacity limit parameter that determines the value at which the resident program is to deem the server to be full.

Preferably the data source comprises at least one database which maintains a file server table.

Preferably the data source relates identities of the file servers to a value indicating whether or not each file server is available for additional file storage.

In a preferred embodiment of the invention the method includes a step wherein the resident program transmits data identifying a created child server or a destroyed child server.

Preferably the resident program monitors file accesses occurring on the file server and transmits one or more data packets indicating quantity of the file accesses to the data source via the said network.

Preferably relationships of the file server to any parent file server and any child file servers thereof are maintained in the database.

In a preferred embodiment of the invention the step of destroying the file server includes updating the relationships stored in the database so that child file servers of the to-be-destroyed file server are indicated to be children of the parent file server of the to-be-destroyed file server.

Alternatively, where the to-be-destroyed file server does not have a parent file server then the first child of the to-be-destroyed file server may be indicated to become the parent of all remaining sibling file servers in the relationships stored in the database.

The method preferably includes a step of maintaining a file table in the database wherein identifiers of files stored in said network of file servers are associated with the identifiers of file servers of the network.

Preferably the step of creating a child file server includes updating the relationships stored in the database to indicate a parent-to-child relationship between the file server and the child file server.

Preferably the method includes a step of transferring at least one file from the file to the newly created child file server subsequent to its creation to thereby bring performance indicators for available storage capacity of the file server below the predetermined capacity limit.

Preferably the step of transferring at least one file comprises transferring every second file of the file server, in order of access frequency, to the newly created child file server and updating the database accordingly to correctly reflect the new location of said files.

The method may include a step of, where a CPU performance indicator is determined by the resident program to exceed the CPU load performance variable, sharing files with a quorum comprising at least one child and/or parent file servers.

The method may include a step of polling file servers of said quorum to identify those file servers having most capacity to receive said shared files.

Preferably the method includes a step of maintaining a record in the database of files that have been duplicated.

Preferably, the method includes, upon detecting duplicated files outside of the File-Lock Time frame parameter, deleting said files in order of eldest to youngest and updating corresponding file records in the database.

According to a further aspect of the present invention there is provided a plurality of file servers interconnected by an electronic data network, said file servers each being virtualization capable, wherein each of said file servers includes at least one processor in communication with an electronic memory device containing instructions for the at least one processors to:

determine performance indicators of the file server, including central processing unit load and available storage capacity;

compare performance indicators of the file server with predetermined file server capacity parameters; and

based on results of the comparison, destroying said file server or creating a child file server to thereby cull superfluous file servers or provide additional file serving capacity respectively.

According to another aspect of the present invention there is provided a computer readable media, for example an optical or magnetic disk or solid state memory device; including tangible machine readable instructions for a computer to carry out the previously described method.

### BRIEF DESCRIPTION OF DRAWINGS

The several Figures illustrate the various steps of the method, where the respective Figures show the following:

FIG. 1—Depicts the topology of a network used in the implementation of a method according to a preferred embodiment of the present invention, the network includes a set of nodes that facilitate the storage and provision of data to users.

FIG. 1A—Is a low level block diagram illustrating a Web Server of FIG. 1.

FIG. 2—Is a diagram about the hierarchical structure of the File Servers and their respective memory allocations.

FIG. 3—Shows a sequence diagram that includes the systems involved in the storage of a new file.

FIG. 4—Illustrates important constant values for the Daemon to be set and the contents of the main fields of the tables in the Central Database.

FIG. 5—Depicts the Evaluation Phase.

FIG. 6a and FIG. 6b—Comprise a flowchart illustrating the Interaction Phase.

FIGS. 7a and 7b—Illustrate the behavior of the File Server Network before and after Apoptosis is performed.

FIGS. 8a, 8b and 8c—Describe the behavior of the File Server Network in the Parthenogenesis process due to a File Server's exceed of Capacity_Limit.

FIGS. 9a and 9b—Describe the behavior of the File Server Network in the Parthenogenesis process when is triggered due to a File Server's average CPU exceeding the Equilibrium_Point and this File Server's Quorum's also exceeding the Equilibrium_Point.

FIGS. 10a and 10b—Describe the behavior of the File Server Network in the Share action.

FIGS. 11a and 11b—Describe the behavior of the File Server Network in the Handover action.

### DESCRIPTION OF PREFERRED EMBODIMENTS OF THE INVENTION

The method described below contains two types of stages for each File Server. The first stage is a phase in which the File Server interacts with other network elements, hereafter called the Interaction Phase, in which new data and requests for serving up data from the Web Server are received.

The other step is called Evaluation Phase. During this stage, tasks are performed to evaluate the status of the File Server. It is at this stage when the Daemon performs checks on the status of its File Server and other File Servers. It will poll certain elements of the File Server and will take decisions according to these values. A constant must be set for the length of time spent doing all these actions. It should be noted that performing this too often will degrade performance and performing this too infrequently will negate any benefits that the Daemon achieves.

Preferred embodiments of the invention described herein to create a hierarchical decentralized network of File Servers. For this, a File Server should evaluate only their own state and the state of his father and children. The concept of Quorum will be used from now on to refer to the immediate parent and the children of this File Server.

It is assumed that the technology that the method that will be described is implemented within, such as Amazon, Rackspace or Microsoft Azure, will provide the usage profiles of any servers that they have created. Currently, all three mentioned services provide statistical analysis packages which provide a detailed view of the functioning of any virtualizations they create.

This is particularly relevant to assessing the operational constants, e.g. equilibrium points required during operation of the method.

It is expected that the implementation of the method to be described on any Cloud framework can be monitored with these pre-existing tools by the administrators of the virtualizations in question. A method according to a preferred embodiment of the invention, as will be described herein is concerned with a de-centralised method for organising virtualizations created by a Cloud network.

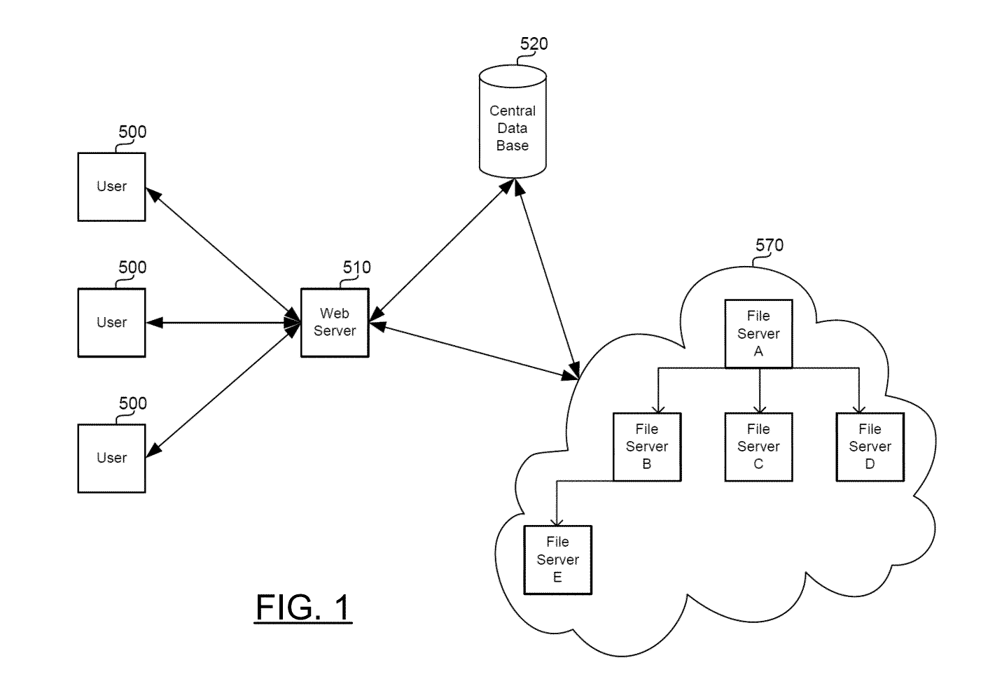

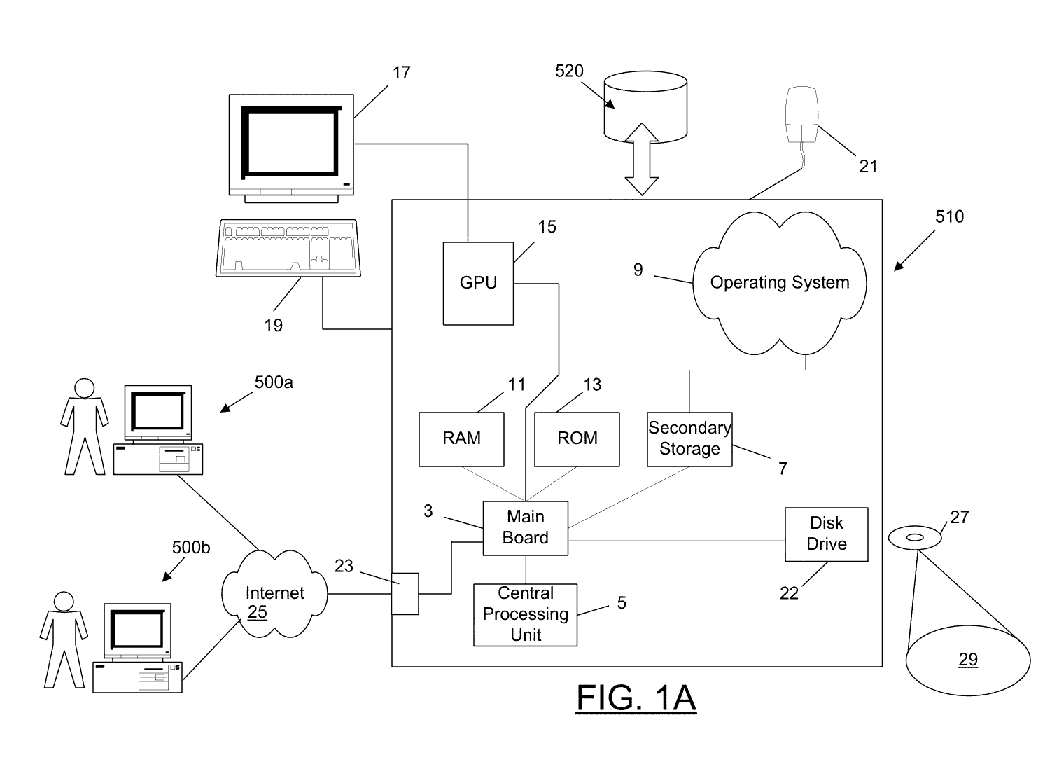

FIG. 1 illustrates various elements of the system. There is a Web Server 510 that is responsible for receiving requests from users 500. There is also a cloud of File Servers 570 that provide and store data. Finally, there is a Central Database 520 that is responsible for registering the File Servers and their content.

FIG. 1A comprises a more detailed diagram of the Web Server 510. The Web Server 510 includes a main board 3 which includes circuitry for powering and interfacing to at least one onboard processor in the form of CPU 5. The at least one onboard processor may comprise two or more discrete processors or processors with multiple processing cores.

The main board 3 acts as an interface between microprocessor 5 and secondary memory 7. The secondary memory 7 will typically comprise one or more optical or magnetic, or solid state, drives. The secondary memory 7 stores instructions for an operating system 9. The main board 3 also communicates with random access memory 11 and read only memory 13. The ROM 13 typically stores instructions for a Basic Input Output System (BIOS) which the microprocessor 5 accesses upon start up and which preps the microprocessor 5 for loading of the operating system 9.

The main board 3 also interfaces with a graphics processor unit 15. It will be understood that in some systems the graphics processor unit 15 is integrated into the main board 3.

The main board 3 will typically include a communications adapter, for example a LAN adaptor or a modem, that places the Web Server 510 in data communication with a computer network such as the internet 25 and so also in communication with remote users 500. Accordingly, the Web-Server, and also the File Servers of FIG. 1, are able to transmit and receive data packets across the data network, e.g. the Internet 25.

An operator of the Web Server 510 is able to interface directly with it by means of keyboard 19, mouse 21 and display 17. Alternatively, as is more often the case for servers an administrator may interface with the computer system across a data network by using a remote terminal application.

A user of Web Server 510 may operate the operating system 9 to load an application for implementing a method according to a preferred embodiment of the invention as will be subsequently described herein. The software application is provided on product 29 is provided as tangible instructions borne upon a computer readable storage media such as optical disk 27. Alternatively it might also be downloaded via port 23. The Web Server 510 is also able to communicate with database 520 either directly or via a data network such as the Internet 25.

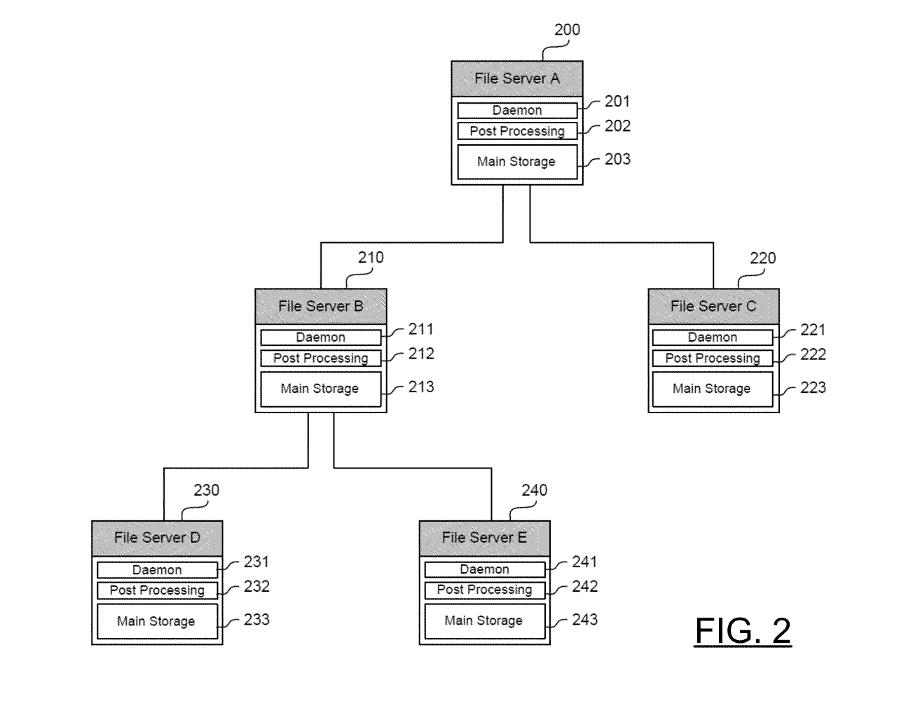

FIG. 2 shows a diagram about the hierarchical structure of the File Servers 200, 210, 220, 230 and 240 and their respective memory allocations. Each File Server contains three different functionalities.

The Daemon 201, 211, 221, 231 and 241 is the resident management program that is responsible for all File Server functions. This will be memory-resident and in continuous operation throughout the life of the File Server.

After data has been received by the File Server, it will be processed and converted for a later storage. This area is called the Post Processing area 202, 212, 222, 232 and 242 will be an area inside the File Server. It constitutes the File Server buffer and should be set to a small percentage of the total File Server's capacity.

Each file that has been processed will be resident in the internet-exposed Main Storage 203, 213, 223, 233 and 243. It is recommended that the File Server will deny any requests that are not submitted through the appropriately secured protocol which is outside the scope of this architecture.

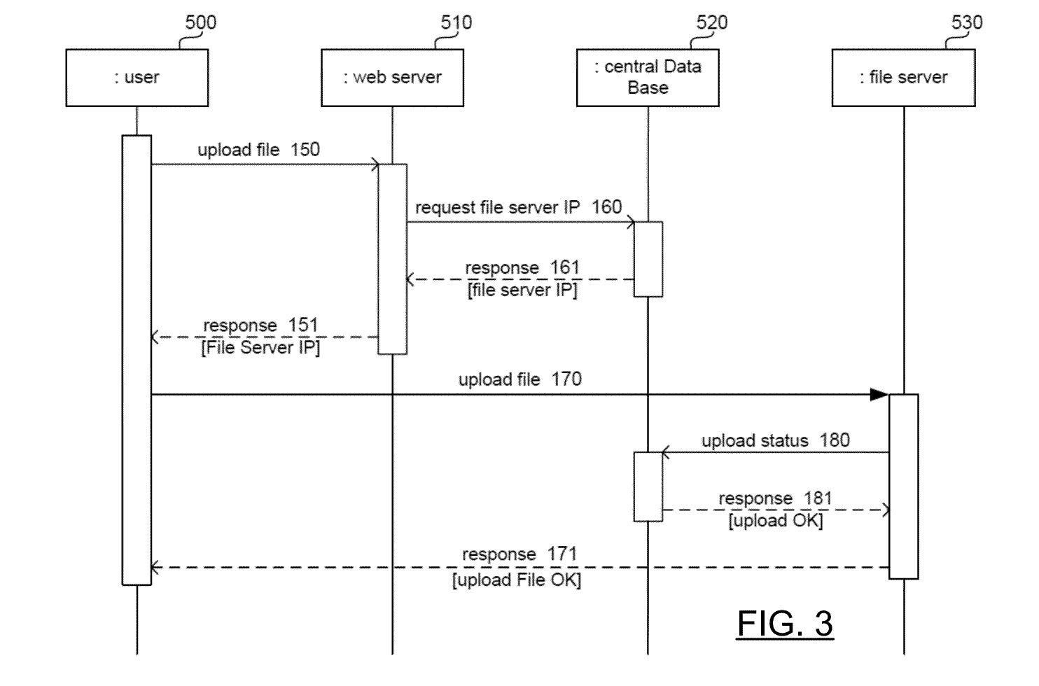

FIG. 3 shows a sequence diagram that includes the systems involved in the storage of a new file. A user 500 requests the web server 510 to upload a file 150. The Web Server 510 queries the Central Database 520 for a suitable recipient of the file. It receives a request for an IP 160 from the Web Server and the Central Database gives it back 161. The Web Server 510 returns the File Server IP 151 to the user 500. This is the point when the user 500 starts uploading the file 170 to the File Server 530. Once this is finished, the File Server has to update its parameter values 180 in the Central Database 520. Then, the Central Database 520 responds 181 to the File Server 530 that the upload of status was done successfully. Finally, the File Server 530 responds 171 to the user 500 that the file was properly uploaded.

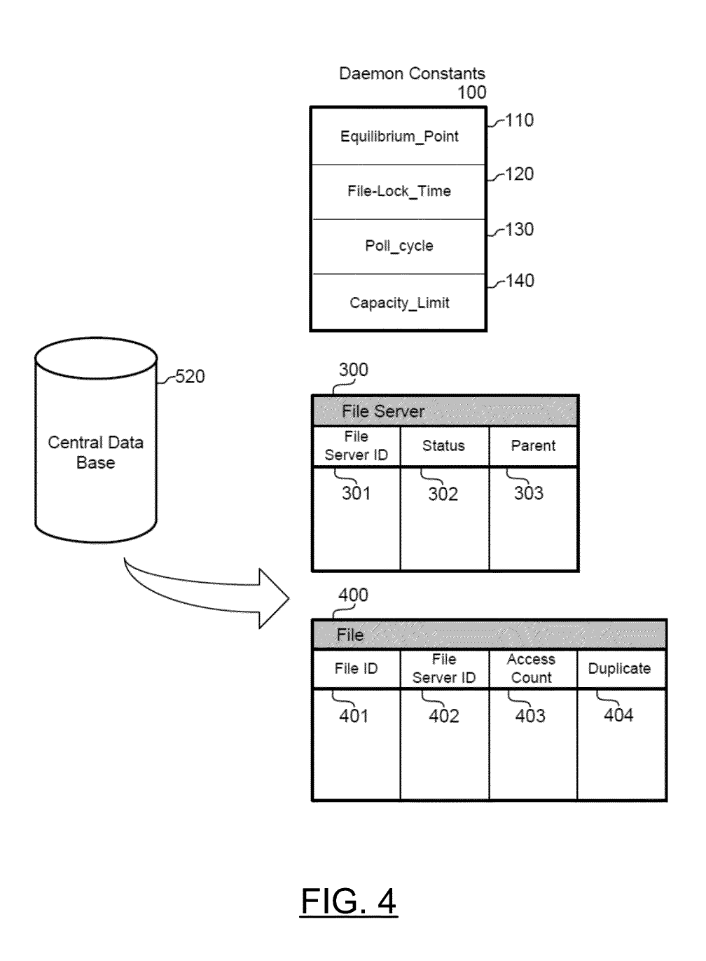

FIG. 4 illustrates important constant values for the Daemon 100 to be set and the contents of the main fields of the tables in the Central Database 520. The Daemon constants 100 are configurable elements used by the File Server Daemon. Equilibrium_Point 110 describes the value for the best operational CPU load in a File Server. This value is expected to change in order to investigate different levels of performance. All decisions made by the Daemon will be geared towards moving File Servers to this equilibrium point. The File-Lock Time 120 is the time that the File Server will be forced to leave a file in its current position. Poll_Cycle 130 is the periodicity that the Daemon will poll certain elements of the File Server. Performing this too often will degrade performance and performing this too infrequently will negate any benefits that the Daemon achieves. Capacity_Limit 140 is a constant that determines the value at which it is considered that the server is sufficiently full.

The File Server table 300 of the Central Database 520 contains a File Server ID 301 that will be unique. Each File Server will have also a Status field 302 with two possible values, Open or Closed, and will determine if the File Server is available for new file storage or not respectively. The File Server table will also contain a field with the parent 303 for each File Server ID 301. When a File Server needs to find its descendants, the server will search the table for its own File_Server_ID 301 that appears in the Parent 303 field.

The File table 400 of the Central Database 520 contains a File ID field 401 that will be unique. There is also included a column for the File_Server_ID 402 that will determine where is the File stored. Access Count 403 will give information about the number of accesses to the file. It will be a useful field to determine the load of a particular file and take actions to rebalance the File Server Network. Duplicate field 404 will say if the File has been duplicated and in such case any duplicated files that are outside of the File-Lock Time frame 120 will be deleted from eldest to youngest.

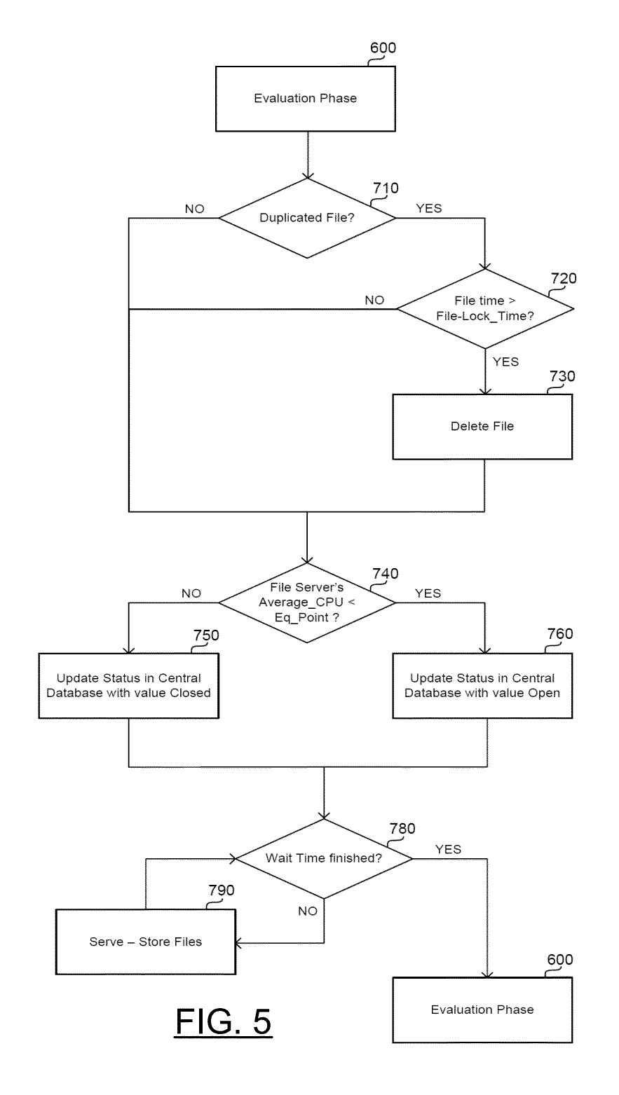

FIG. 5 illustrates the Interaction Phase. This process starts just after the Evaluation Phase 600 and consists of three stages:

First there will be a Delete stage, when every duplicated file which is outside the File-Lock_Time frame will be deleted. The Daemon will review its list of files on the Central Database and every file tagged as duplicated 710 and that exceeds the File-Lock_Time 720 will be deleted 730 in the Daemon' s File Server and will also be removed the information recorded in the Central Database about that deleted file.

Second, the Daemon will check its current capacity in the Update stage. If the File Server's CPU load is under the Equilibrium_Point constant 740, it will update its Status in the Central Database's table for File Servers with value Open 760. If the File Server's CPU load is at the same value as the Equilibrium_Point constant or higher, it will update its Status to Closed 750.

Finally, the File Server will start the Wait stage. This consists of making the Daemon wait a certain length of time 780 while it continues with other activities. It's during this time that the File Server will perform its main role of serving up or storing files 790. The Web Server will select one File Server with Open Status to upload new files. If the Daemon of the File Server selected acknowledges its ability to accept a new file, then the Web Server will direct the upload to this File Server. This consequently will require CPU and disk space usage.

Once these steps are completed, the system starts the Evaluation Phase 600.

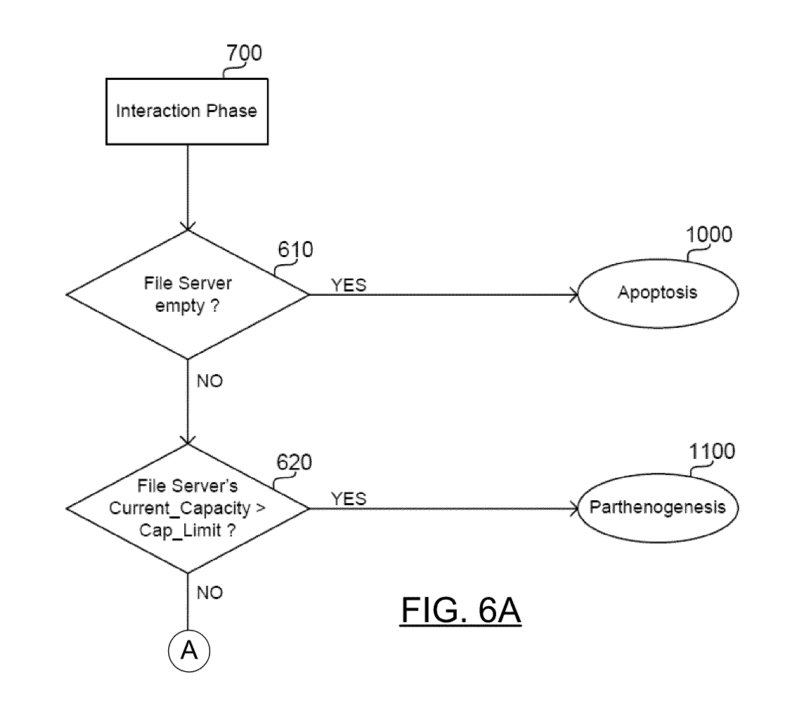

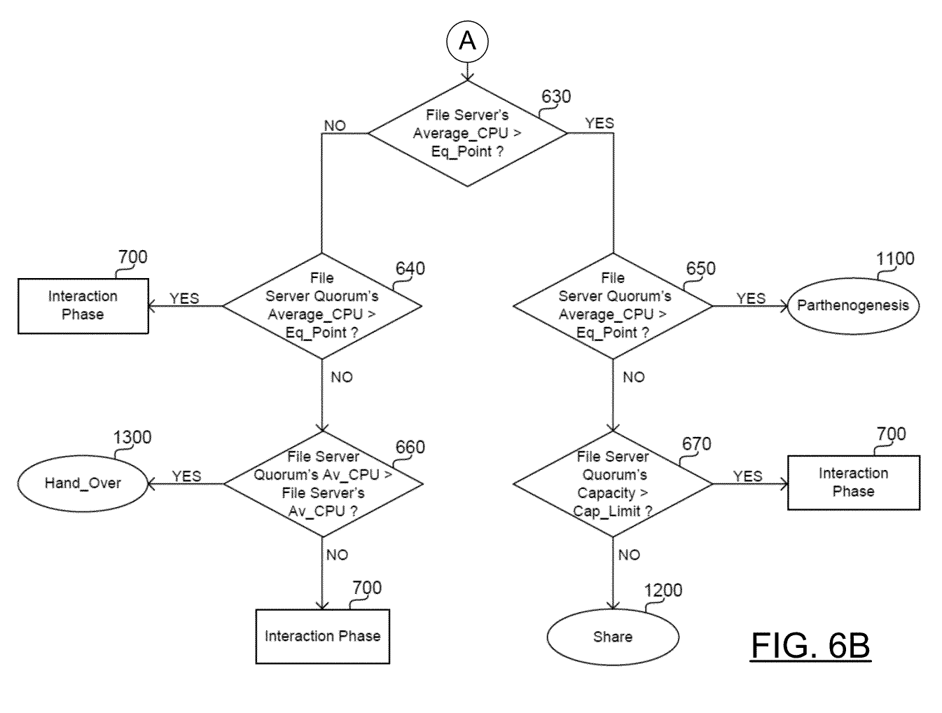

FIG. 6 depicts the Evaluation Phase. Once ends the Interaction Phase 700, the Daemon checks if the capacity of the File Server is empty 610. If it is empty, the File Server itself is disabled, this is called Apoptosis 1000. If it is not empty, the Daemon checks if the capacity is above the limit defined as a constant Capacity_Limit 620, If so, the File Server will commission a new File Server, this is called Parthenogenesis 1100. If the capacity of the File Server is below the Capacity_Limit 620, the Daemon checks the CPU load on its File Server and its Quorum. If the CPU usage of the File Server exceeds the Equilibrium Point 630 and the CPU usage of its Quorum exceeds the Equilibrium Point 650 then, there are not resources enough to maintain an acceptable performance, and a new File Server is needed. The Daemon will commission a new File Server, triggering Parthenogenesis 1100. If the CPU usage of the File Server exceeds the Equilibrium Point 630 and the CPU usage of the File Server Quorum do not exceed the Equilibrium_Point 650 and the File Server Quorum's capacity is below the Capacity_Limit 670 then the File Server's Daemon will decide to Share 1200 one of its files with a member of its Quorum. Finally, if the File Server is under the Equilibrium_Point 630 and its Quorum are under the Equilibrium_Point 640 too but the File Server's Quorum's CPU usage is greater than the File Servers 660, then Hand Over a file 1300.

First case is the Apoptosis. The File-Server will decommission and de-activate itself. All children of the File-Server will gain the parent of the File-Server. In the absence of a parent, the first child will become the parent all remaining siblings. In the absence of multiple children, no further action need be taken.

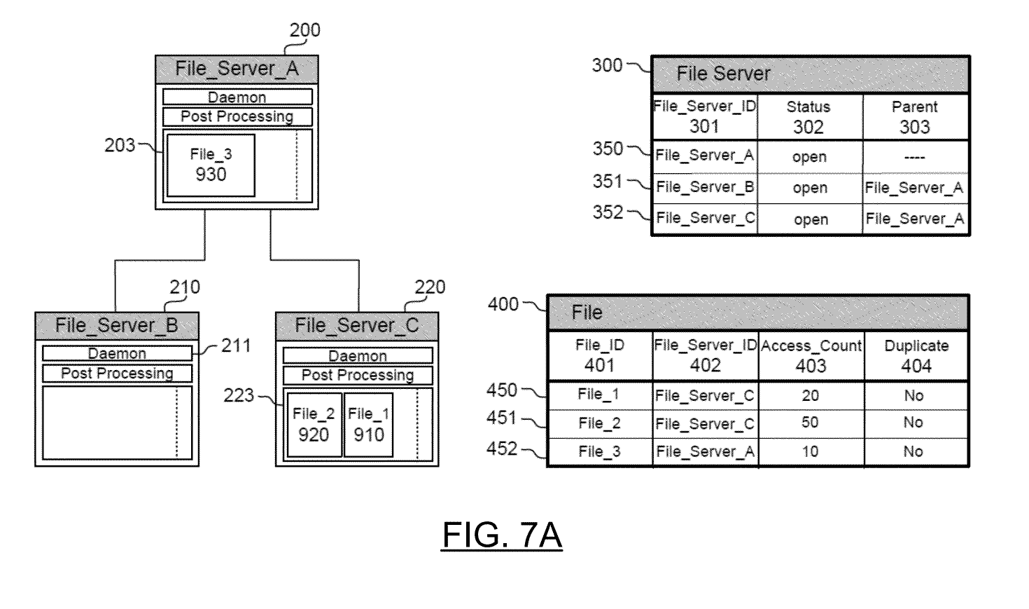

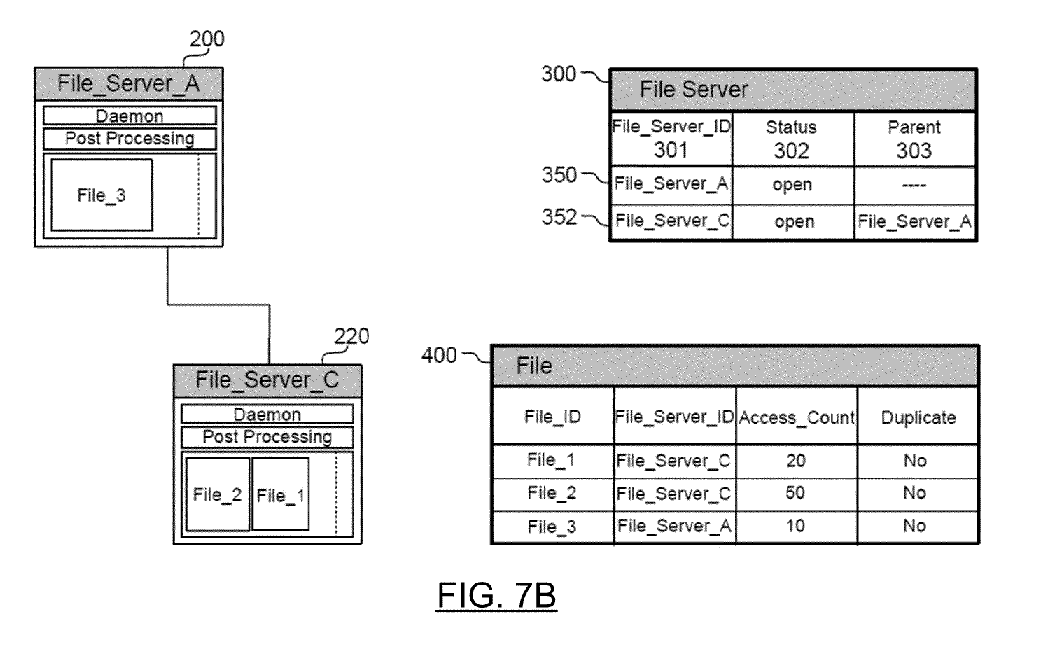

FIG. 7a illustrates the initial situation of the File Server Network before Apoptosis is performed; in this illustration there are three nodes, File_Server_A 200, File_Server_B 210 and File_Server_C 220. File_Server_A 200 contains in its Main Storage 203 one file named File_3 930. File_Server_B 210 is empty. File_Server_C 220 contains in its Main Storage 223 two files named File_2 920 and File_1 910.

There are also two Central Database tables included in the illustration, File Server table 300 and File table 400.

File Server table 300 content is as follows: There are three rows in the File_Server_ID 301 these are File_Server_A 350, File_Server_B 351 and File_Server_C 352. The current status 302 for these File Servers is Open for all of them. This table also contains the hierarchy of the File Servers, in the Parent column 303 it is shown that File_Server_B 351 and File_Server_C 352 have File_Server_A as a parent.

File table 400 contains the following information: There are three File_IDs 401: File_1 450, File_2 451 and File_3 452. These files are located in different File Servers identified by the File_Server_ID 402; in this case File_1 450 is located in File_Server_C; File_2 451 is also located in File_Server_C and File_3 452 is located in File_Server_A. The number of accesses to each file is registered in Access_Count 403 field; File_1 450 has been accessed 20 times; File_2 451 has been accessed 50 times and File_3 452 has been accessed 10 times. Finally, none of these files appear as duplicated in the Duplicate 404 field.

Once the Evaluation Phase starts, File_Server_B's Daemon 211 will evaluate its own status and will find that it is empty. This situation triggers an Apoptosis of the File_Server_B 210.

FIG. 7b depicts the File Server Network after the Apoptosis of File_Server_B. In this case, there are only two nodes in the network: File_Server_A 200 and File_Server_C 220.

File Server table 300 has been updated. There are only two File_Server_IDs 301 in the table after Apoptosis: File_Server_A 350 and File_Server_C 352. File_Server_B has been deleted from the table. The current status 302 for these File Servers is Open for the two of them. This table also contains the hierarchy of the File Servers, in the Parent column 303 it is shown that File_Server_C 352 has File_Server_A as a parent.

There are no changes in File table 400 after Apoptosis is performed in this example.

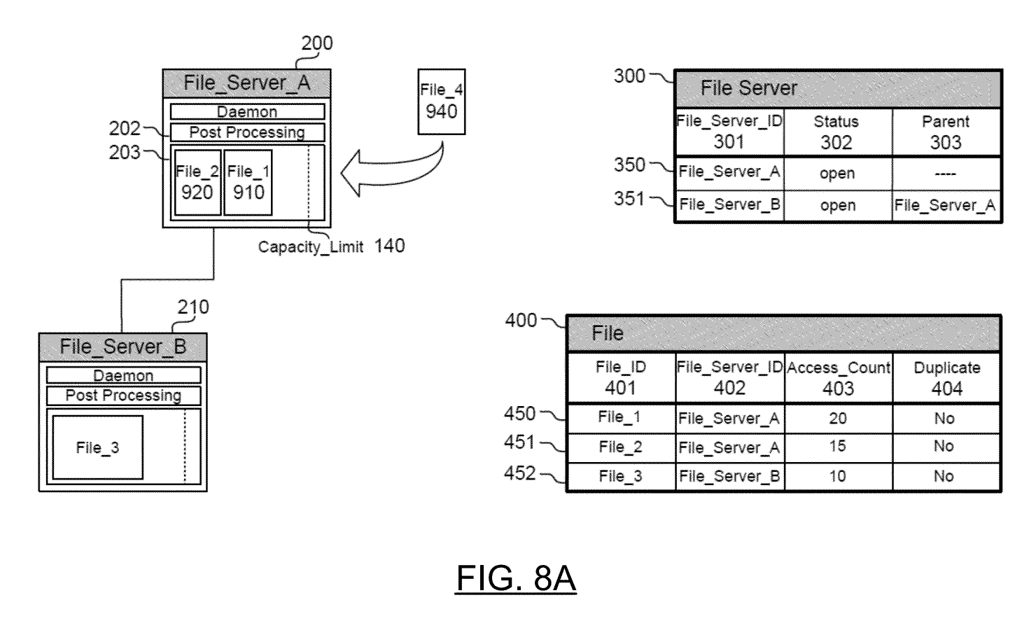

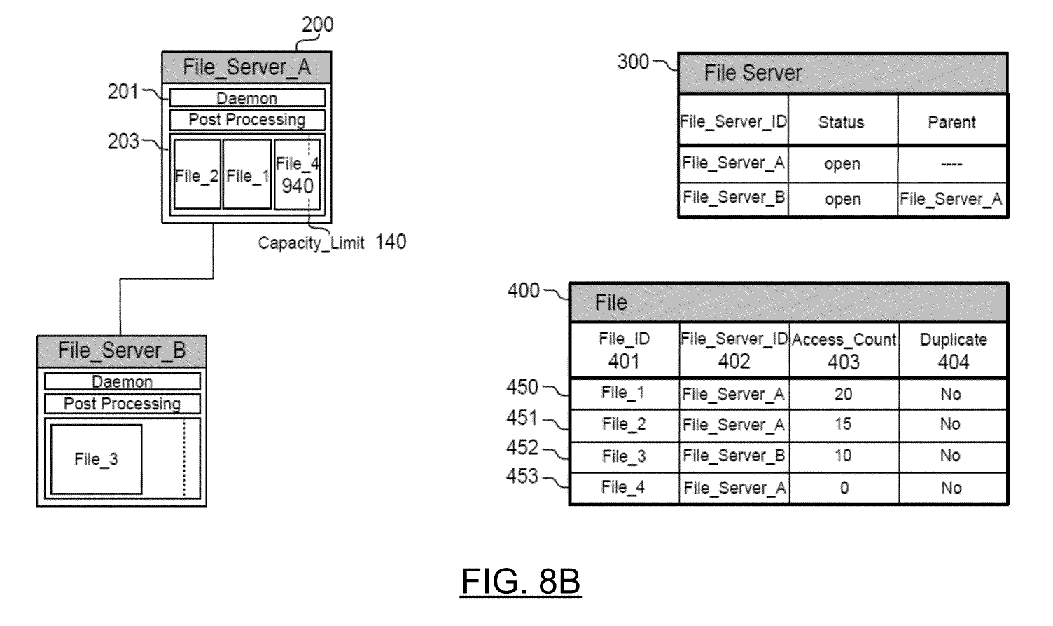

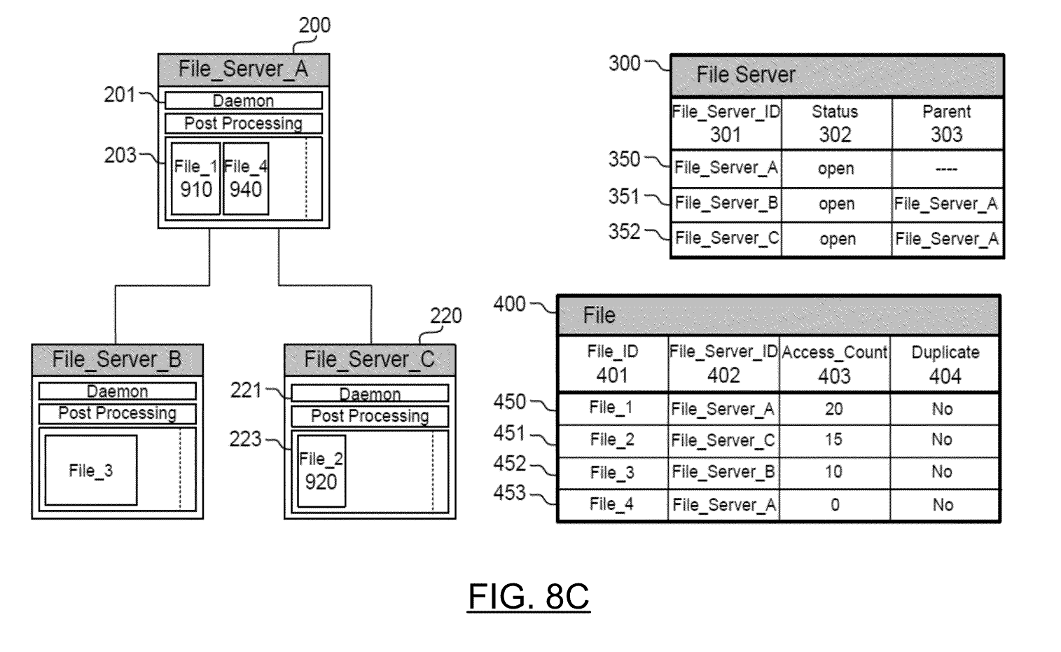

FIG. 8a describes the initial state of the system before Parthenogenesis is triggered due to the File Server exceeding the Capacity_Limit.

In this illustration are shown two File Servers: File_Server_A 200 and File_Server_B 210. After the Interaction Phase, File_Server_A 200 is receiving a new file File_4 940 to store. This file will be processed in the Post Processing area 202 and after will be stored in the Main Storage Area 203. This area already contains two files: File_2 920 and File_1 910. File_Server_A 200 current capacity is under the Capacity_Limit 140.

There are also two Central Database tables included in the illustration, File Server table 300 and File table 400.

File Server table 300 content is as follows: There are two rows in File_Server_ID 301 column these are File_Server_A 350 and File_Server_B 351. The current status 302 for these File Servers is Open. This table also contains the hierarchy of the File Servers, in the Parent column 303 it is shown that File_Server_B 351 has File_Server_A as a parent.

File table 400 contains the following information: There are three File_IDs 401: File_1 450, File_2 451 and File_3 452. These files are located in different File Servers identified by the File_Server_ID 402; in this case File_1 450 is located in File_Server_A; File_2 451 is also located in File_Server_A and File_3 452 is located in File_Server_B. The number of accesses to each file is registered in Access_Count 403 field; File_1 450 has been accessed 20 times; File_2 451 has been accessed 15 times and File_3 452 has been accessed 10 times. Finally, none of these files appear as duplicated in the Duplicate 404 field.

FIG. 8b shows how File_Server_A 200 has stored File_4 940 in the Main Storage Area 203 and this file exceeds the Capacity_Limit 140, due to this, when File_Server_A's Daemon checks its own capacity in the Evaluation Phase and Parthenogenesis is triggered.

File Server table 300 remains the same but File table 400 has been updated: There are four File_IDs 401: File_1 450, File_2 451, File_3 452 and File_4 453. These files are located in different File Servers identified by the File_Server_ID 402; in this case File_1 450 is located in File_Server_A; File_2 451 is also located in File_Server_A; File_3 452 is located in File_Server_B and File_4 453, the new file stored in the server, is located in File_Server_A. The number of accesses to each file is registered in Access_Count 403 field; File_1 450 has been accessed 20 times; File_2 451 has been accessed 15 times, File_3 452 has been accessed 10 times and File_4 has value 0 as has just been stored and not has been accessed yet. Finally, none of these files appear as duplicated in the Duplicate 404 field.

FIG. 8c describes the final state of the system after Parthenogenesis is performed. In this case, a new File Server is created, File_Server_C 220. The new file server, File_Server_C 220, is empty and lacks the functionality of other network elements. The Daemon 201 of the parent File_Server_A 200 will be responsible for creating the separate memory limitations in the new File_Server_C 220. Subsequently, the Daemon 201 will copy the code and activate the new Daemon 221 in the newly created File_Server_C 220. The Daemon 201 will also create an entry in the Central Database creating a new row in this table, where this new File_Server_C will record the information necessary for the network to be managed properly.

The parent File_Server_A 200 sorts its files File_1 910, File_2 920 and File_4 940 by their Access_Count 403, consulting the Central Database Table for Files 400. In this particular case, when the File_Server_A's Daemon 201 checks column Access_Count 403, to evaluate its files and obtains the following list: File_1 is the most accessed with value 20, followed by File_2 with value 15 and finally File_4 with value 0. Every second file in this sorted list will be moved to the child File_Server_C 220. In this case, File_2 920 is stored in File_Server_C 220 and deleted in File_Server_A 200. Then, File_Server_C's Daemon 221 will update the Central Database table for Files 400 to record the new location of this file.

File Server table 300 content after performing this operation will be as follows: There are three rows in File_Server_ID 301 column these are File_Server_A 350, File_Server_B 351 and File_Server_C 352. The current Status 302 for these File Servers is Open. This table also contains the hierarchy of the File Servers, in the Parent column 303 it is shown that File_Server_B 351 and File_Server_C 352 have File_Server_A as a parent

File table 400 contains the following information: There are four File_IDs 401: File_1 450, File_2 451, File_3 452 and File_4 453. These files have changed their previous location and now are located in the following File Servers identified by the File_Server_ID 402; in this case File_1 450 is located in File_Server_A; File_2 451 is located in File_Server_C; File_3 452 is located in File_Server_B and File_4 is located in File_Server_A 453. The number of accesses to each file is registered in Access_Count 403 field; File_1 450 has been accessed 20 times; File_2 451 has been accessed 15 times; File_3 452 has been accessed 10 times and File_4 453 has not been accessed. Finally, none of these files appear as duplicated in the Duplicate 404 field.

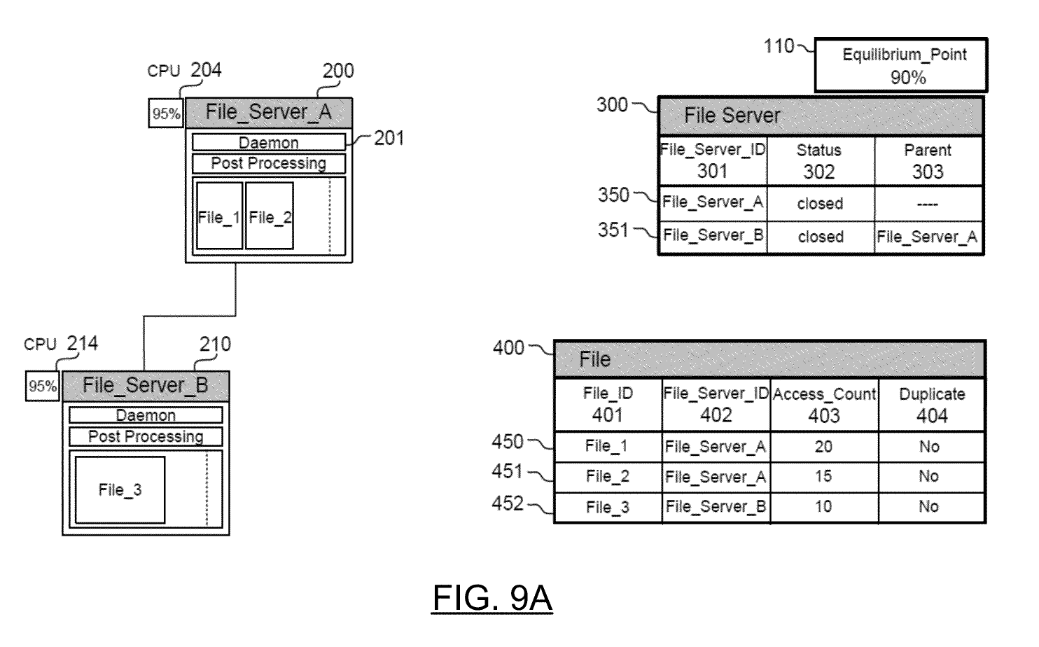

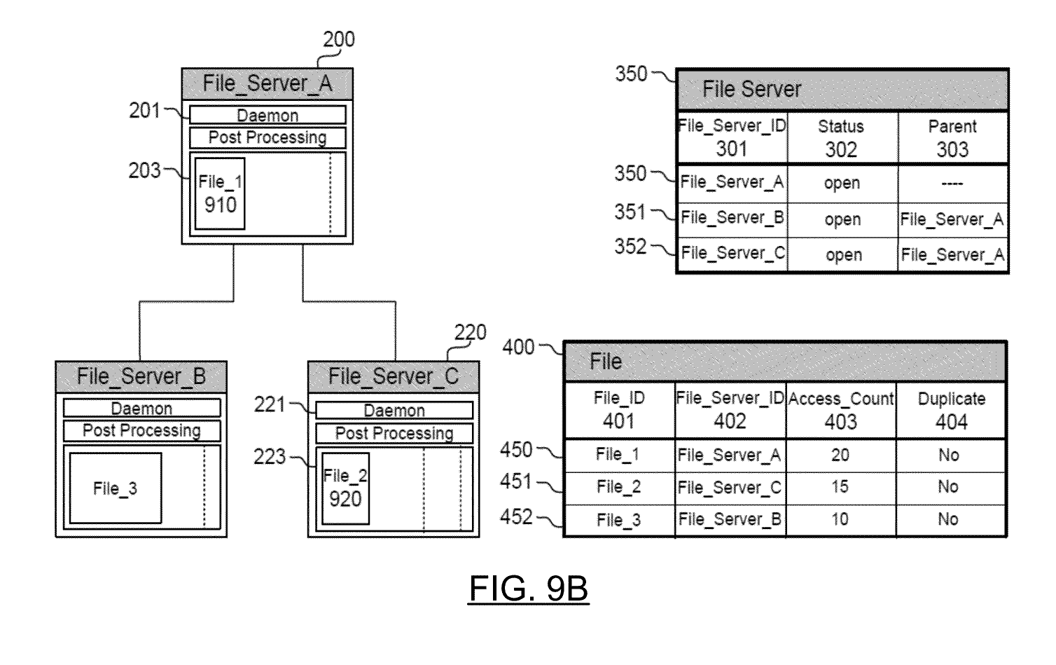

FIG. 9a describes the initial state of the system before Parthenogenesis is triggered due to the File Server's average CPU exceeding the Equilibrium_Point 110 and File Server's Quorum's average CPU also excees the Equilibrium_Point 110.

In this illustration are shown two File Servers: File_Server_A 200 that is the parent of File_Server_B 210. The Equilibrium_Point 110 value is 90%.

The process of Parthenogenesis action starts when File_Server_A's Daemon 201 evaluates its status in the Evaluation Phase, and finds that its CPU load 204 is 95%. File_Server_A's Quorum is File_Server_B 210. CPU load 214 in File_Server_B is 95%. The CPU load average for File_Server_A's Quorum is consequently 95%. In accordance with these values, File_Server_A's CPU load 204, 95%, is above the Equilibrium_Point 110, 90%, and the average CPU of its Quorum, 95%, is also above the Equilibrium_Point 110. Parthenogenesis action of File_Server_A 200 is triggered.

There are also two Central Database tables included in the illustration, File Server table 300 and File table 400.

File Server table 300 content is as follows: There are two rows in File_Server_ID 301 column these are File_Server_A 350 and File_Server_B 351. The current status 302 for these File Servers is Closed due to its CPU usage being above the Equilibrium_Point. This table also contains the hierarchy of the File Servers, in the Parent column 303 it is shown that File_Server_B 351 has File_Server_A as a parent.

File table 400 contains the following information: There are three File_IDs 401: File_1 450, File_2 451 and File_3 452. These files are located in different File Servers identified by the File_Server_ID 402; in this case File_1 450 is located in File_Server_A; File_2 451 is also located in File_Server_A and File_3 452 is located in File_Server_B. The number of accesses to each file is registered in Access_Count 403 field; File_1 450 has been accessed 20 times; File_2 451 has been accessed 15 times and File_3 452 has been accessed 10 times. Finally, none of these files appear as duplicated in the Duplicate 404 field.

FIG. 9b shows the final state of the System after Parthenogenesis of File_Server_A 200 is performed. In this case, a new File Server is created, File_Server_C 220. The new file server, File_Server_C 220, is empty and lacks the functionality of other network elements. The Daemon 201 of the parent File_Server_A 200 will be responsible for creating the separate memory limitations in the new File_Server_C 220. Subsequently, the Daemon 201 will copy the code and activate the new Daemon 221 in the newly created File_Server_C 220. The Daemon 201 will also create an entry in the Central Database creating a new row in this table, where this new File_Server_C 220 will record the information necessary for the network to be managed properly.

The parent File_Server_A 200 sorts its files File_1 910 and File_2 920 by their Access_Count 403, consulting the Central Database Table for Files 400. In this particular case, when the File_Server_A's Daemon 201 checks column Access_Count 403, to evaluate its files and obtains the following list: File_1 is the most accessed with value 20, followed by File_2 with value 15. Every second file in this sorted list will be moved to the child File_Server_C 220. So in this case, File_2 920 is stored in File_Server_C 220 and deleted in File_Server_A 200. Then, File_Server_C's Daemon 221 will update the Central Database table for Files 400 to record the new location of this file.

File Server table 300 content after performing this operation will be as follows: There are three rows in File_Server_ID 301 column these are File_Server_A 350, File_Server_B 351 and File_Server_C 352. The current status 302 for these File Servers has changed to Open; this is due to their CPU load having decreased to under the Equilibrium_Point. This table also contains the hierarchy of the File Servers, in the Parent column 303 it is shown that File_Server_B 351 and File_Server_C 352 have File_Server_A as a parent.

File table 400 contains the following information: There are three File_IDs 401: File_1 450, File_2 451 and File_3 452. These files have changed their previous location and now are located in the following File Servers identified by the File_Server_ID 402; in this case File_1 450 is located in File_Server_A; File_2 451 has changed its previous place and is now located in File_Server_C and File_3 452 is located in File_Server_B. The number of accesses to each file is registered in Access_Count 403 field; File_1 450 has been accessed 20 times; File_2 451 has been accessed 15 times; File_3 452 has been accessed 10 times. Finally, none of these files appear as duplicated in the Duplicate 404 field.

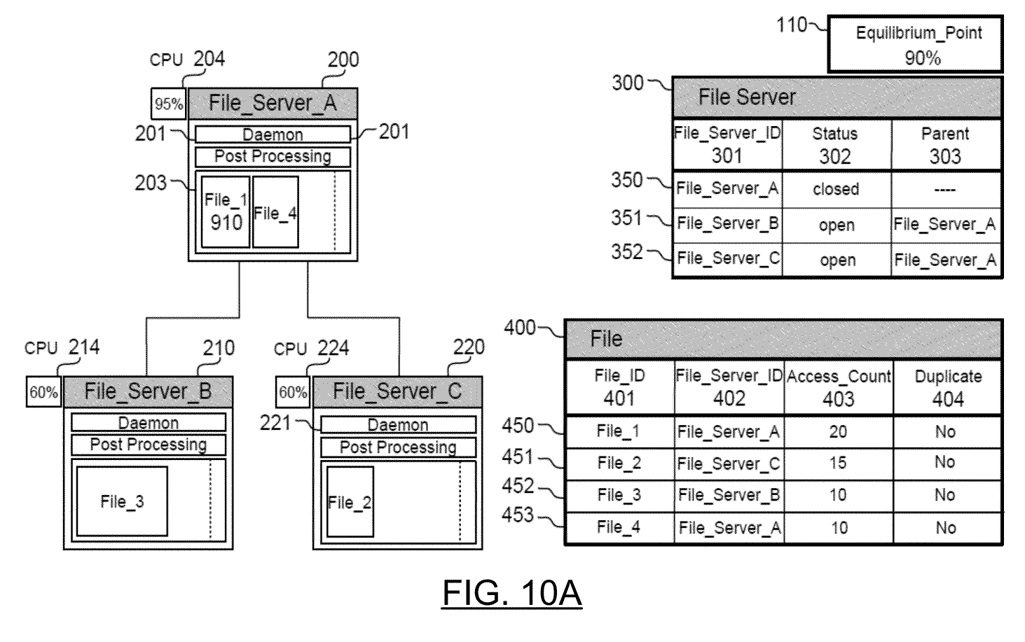

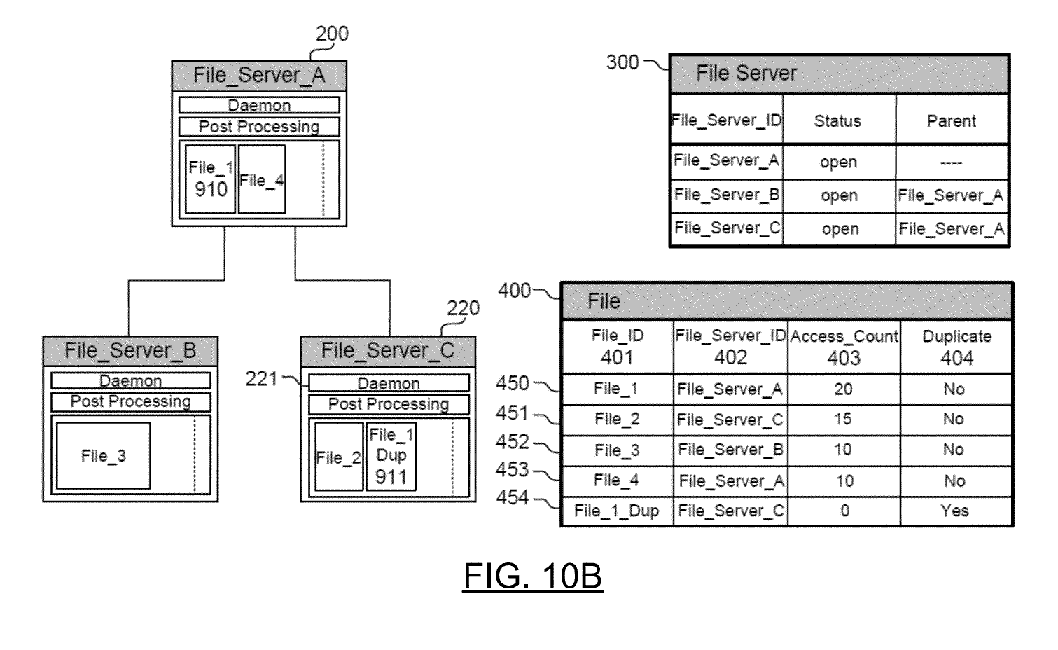

FIG. 10a describes the initial state of the system before Share action is triggered. This happens when a File Server experiences high requests for a particular file, or has detected that a particular file will shortly be in high request. If the CPU usage of the File Server exceeds the Equilibrium_Point 110 and the File Server's Quorum has spare capacity and is not under a heavy load, then files will be shared.

In this figure, the File Server Network contains three File Servers: File_Server_A 200 is the parent of File_Server_B 210 and File_Server_C 220. The Equilibrium_Point 110 value is 90%.

The process of Share action starts when File_Server_A's Daemon 201 evaluates its status in the Evaluation Phase, and finds that its CPU load 204 is 95%. File_Server_A's Quorum is File_Server_B 210 and File_Server_C 220. CPU load 214 in File_Server_B is 60%. CPU load 224 in File_Server_C is 60%. The CPU load average for File_Server_A's Quorum is consequently 60%. In accordance with these values, File_Server_A's CPU load 204, 95%, is above the Equilibrium_Point 110, 90%, and the average CPU of its Quorum, 60%, is below the Equilibrium_Point 110. Share action of File_Server_A 200 is triggered.

The Daemon 201 first selects the file that has been accessed the most. In Central Database table for Files 400 the Access Count 403 for the File_Server_A files is: File_1 450 with value 20 and File_4 453 with value 10. File_1 450 that is the one most requested will be shared with other File Server of File_Server_A's Quorum. To determine which of the members of its Quorum is the most appropriate to receive the file a poll will be performed among members of the Quorum, in this particular case, File_Server_B 210 and File_Server_C 220. Then, the Daemon 201 should communicate with the Daemon 221 of the File Server that will store the copy, in this case File_Server_C 220 to get ready for the reception of File_1 910.

File Server table 300 content will appear in the Central Database as follows: There are three rows in File_Server_ID 301 column these are File_Server_A 350, File_Server_B 351 and File_Server_C 352. The current Status 302 for these File Servers is Closed for File_Server_A 350 due to its CPU usage being above the Equilibrium_Point; Open for File_Server_B 351 and Open for File_Server_C 352. This table also contains the hierarchy of the File Servers, in the Parent column 303 it is shown that File_Server_B 351 and File_Server_C 352 have File_Server_A as a parent.

File table 400 contains the following information: There are four File_IDs 401: File_1 450, File_2 451, File_3 452 and File_4 453. These files are located in the following File Servers identified by the File_Server_ID 402; in this case File_1 450 is located in File_Server_A; File_2 451 is located in File_Server_C; File_3 452 is located in File_Server_B and File_4 is located in File_Server_A 453. The number of accesses to each file is registered in Access_Count 403 field; File_1 450 has been accessed 20 times; File_2 451 has been accessed 15 times; File_3 452 has been accessed 10 times and File_4 453 has been accessed 10 times. Finally, none of these files appear as duplicated in the Duplicate 404 field.

FIG. 10b depicts the final state for the system after a Share action has been performed. When File_Server_C 220 starts again its Interaction Phase, it will find the request from File_Server_A 200 to store a copy of File_1 910 that will be called File_1_Dup 911. Once processed and stored properly, its Daemon 221 updates the Central Database table for Files 400 including a new row for File_1_Dup 911 labeling Duplicate Column 404 with Yes. This will create an entry in the Central Database record to indicate the existence of multiple locations for the file.

File Server table 300 content after performing this operation will be as follows: There are three rows in File_Server_ID 301 column these are File_Server_A 350, File_Server_B 351 and File_Server_C 352. The current status 302 for these File Servers has changed to Open; this is due to their CPU load has decreased under the Equilibrium_Point. This table also contains the hierarchy of the File Servers, in the Parent column 303 it is shown that File_Server_B 351 and File_Server_C 352 have File_Server_A as a parent.

File table 400 will be updated with the following information: There are five File_IDs 401: File_1 450, File_2 451, File_3 452, File_4 453 and File_1_Dup 454. These files have changed their previous location and now are located in the following File Servers identified by the File_Server_ID 402; in this case File_1 450 is located in File_Server_A; File_2 451 is located in File_Server_C; File_3 452 is located in File_Server_B, File_4 is located in File_Server_A 453 and the duplicated file File_1_Dup 454 will be located in File_Server_C. The number of accesses to each file is registered in Access_Count 403 field; File_1 450 has been accessed 20 times; File_2 451 has been accessed 15 times; File_3 452 has been accessed 10 times; File_4 453 has been accessed 10 times and the just duplicated file File_1_Dup 454 has not been accessed yet. Finally, in the Duplicate 404 field File_1_Dup 454 appears as duplicated.

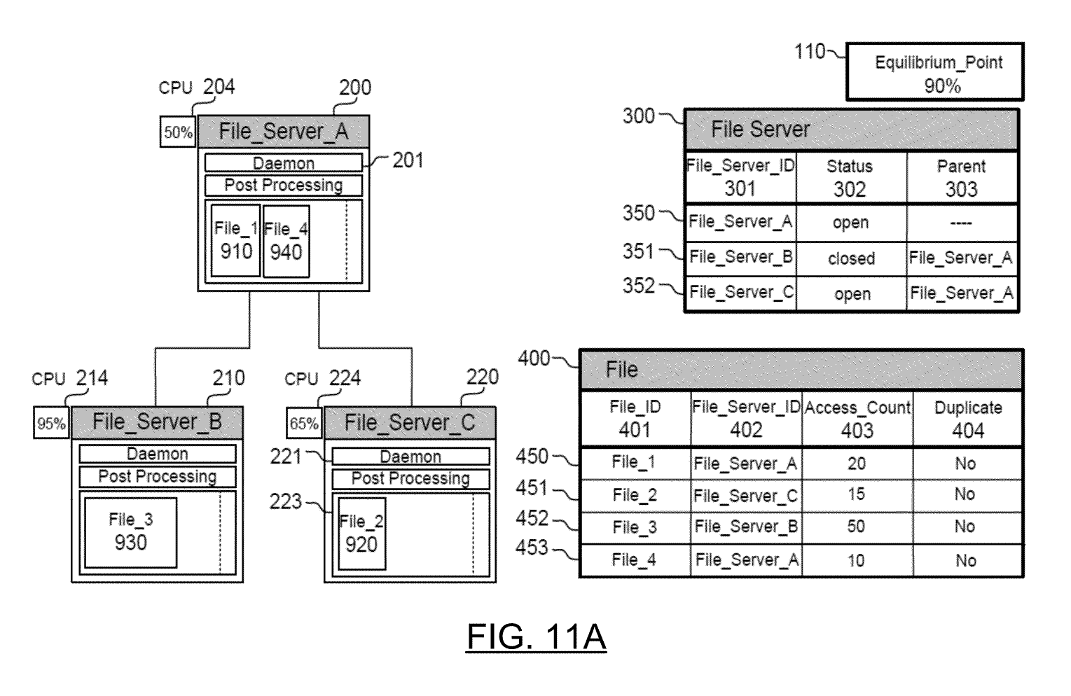

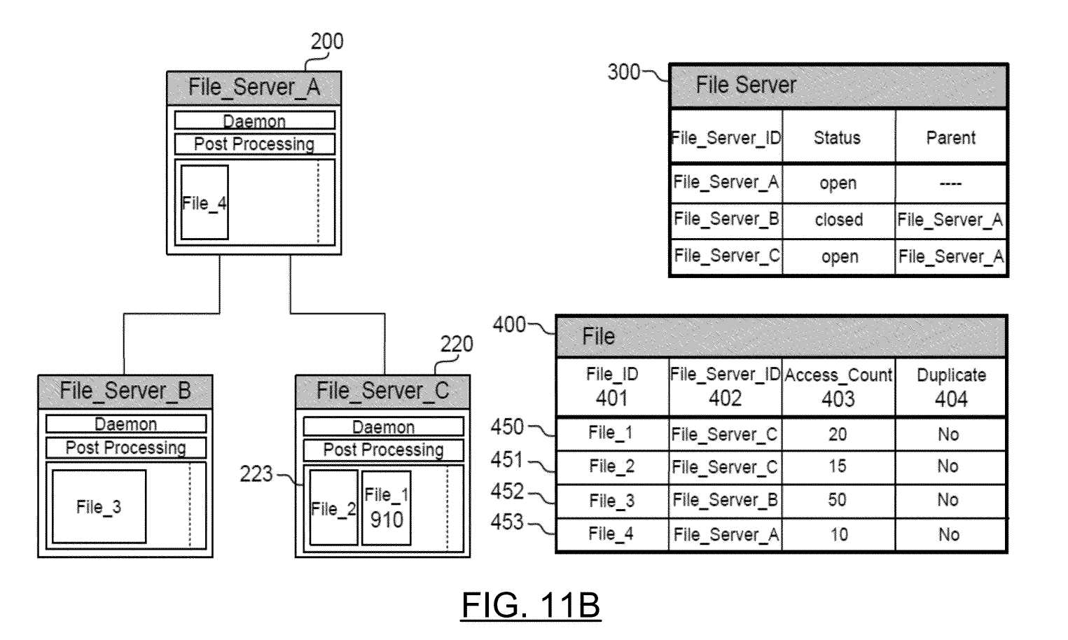

FIG. 11a describes the initial state of the system before Hand_Over action is triggered. If the CPU usage of the File Server is below the Equilibrium_Point 110 and the File Server's Quorum's CPU usage is below the Equilibrium_Point and the File Server's Quorum's CPU usage is greater than the File Server's CPU usage, then Hand-Over a file.

In this figure, the File Server Network contains three File Servers: File_Server_A 200 that is the parent of File_Server_B 210 and File_Server_C 220. The Equilibrium_Point 110 value is 90%.

The process of Hand_Over action starts when File_Server_A's Daemon 201 evaluates its status in the Evaluation Phase, and finds that its CPU load 204 is 50%. File_Server_A's Quorum is File_Server_B 210 and File_Server_C 220. CPU load 214 in File_Server_B is 95% and CPU load 224 in File_Server_C is 65%. The CPU load average for File_Server_A's Quorum is consequently 80%. In accordance with these values, File_Server_A's CPU load 204, 50%, is below the Equilibrium_Point 110, 90%, and also below the average CPU of its Quorum, 80%. This implies that the Network is not under a proper equilibrium and the Daemon 201 will select one of the Files stored in the Main Storage Area 203 of File_Server_A 200 to relocate it in other of the File Servers. File_Server_B's Status 302 is Closed, so the Daemon 201 will chose File_Server_C, which has an Open Status 302, to receive the file. It will send a relocation request to File_Server_C's Daemon 221 to store File_1 910 in its File Server.

File Server table 300 content appears in the Central Database as follows: There are three rows in File_Server_ID 301 column these are File_Server_A 350, File_Server_B 351 and File_Server_C 352. The current Status 302 for these File Servers is Open for File_Server_A 350; Closed for File_Server_B 351 due to its CPU usage being above the Equilibrium_Point and Open for File_Server_C 352. This table also contains the hierarchy of the File Servers, in the Parent column 303 it is shown that File_Server_B 351 and File_Server_C 352 have File_Server_A as a parent.

File table 400 contains the following information: There are four File_IDs 401: File_1 450, File_2 451, File_3 452 and File_4 453. These files are located in the following File Servers identified by the File_Server_ID 402; in this case File_1 450 is located in File_Server_A; File_2 451 is located in File_Server_C; File_3 452 is located in File_Server_B and File_4 is located in File_Server_A 453. The number of accesses to each file is registered in Access_Count 403 field; File_1 450 has been accessed 20 times; File_2 451 has been accessed 15 times; File_3 452 has been accessed 50 times and File_4 453 has been accessed 10 times. Finally, none of these files appear as duplicated in the Duplicate 404 field.

FIG. 11b shows the final state of the System after Hand_Over is performed. In this case, File_1 910 has been deleted from File_Server_A 200 and has been stored in File_Server_C's 220 Main Store area 223.

After Hand_Over Action, File Server table 300 content will remain the same as previously but File table 400 will be updated with the following information: There are four File_IDs 401: File_1 450, File_2 451, File_3 452 and File_4 453. These files have changed their previous location and now are located in the following File Servers identified by the File_Server_ID 402; in this case File_1 450 has changed and now is located in File_Server_C; File_2 451 is located in File_Server_C; File_3 452 is located in File_Server_B and File_4 is located in File_Server_A 453. The number of accesses to each file is registered in Access_Count 403 field; File_1 450 has been accessed 20 times; File_2 451 has been accessed 15 times; File_3 452 has been accessed 10 times and File_4 453 has been accessed 10 times. Finally, none of these files appear as duplicated in the Duplicate 404 field.

Implementations of the present disclosure and all of the functional operations provided herein can be realized in digital electronic circuitry, or in computer software, firmware, or hardware, including the structures disclosed in this specification and their structural equivalents, or in combinations of one or more of them. Implementations of the invention can be realized as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the present disclosure can be realized in a computing system that includes a back end component, e.g., as a data server, or that includes a middleware component, e.g., an application server, or that includes a front end component, e.g., a client computer having a graphical user interface or a Web browser through which a user can interact with an implementation of the present disclosure, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this disclosure contains many specifics, these should not be construed as limitations on the scope of the disclosure or of what may be claimed, but rather as descriptions of features specific to particular implementations of the disclosure. Certain features that are described in this disclosure in the context of separate implementations can also be provided in combination in a single implementation. Conversely, various features that are described in the context of a single implementation can also be provided in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the present disclosure have been described. Other implementations are within the scope of the following claims. For example, the actions recited in the claims can be performed in a different order and still achieve desirable results.

In compliance with the statute, the invention has been described in language more or less specific to structural or methodical features. The term “comprises” and its variations, such as “comprising” and “comprised of” is used throughout in an inclusive sense and not to the exclusion of any additional features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Throughout the specification and claims (if present), unless the context requires otherwise, the term “substantially” or “about” will be understood to not be limited to the value for the range qualified by the terms.

Any embodiment of the invention is meant to be illustrative only and is not meant to be limiting to the invention. Therefore, it should be appreciated that various other changes and modifications can be made to any embodiment described without departing from the spirit and scope of the invention.

What is claimed is:

1. A method for balancing file server load across a plurality of file servers interconnected by an electronic data network, said file servers each being virtualization capable, the method comprising the steps of, for each of said file servers:
operating a program resident on the file server to determine performance indicators of the file server;
comparing performance indicators of the file server with predetermined file server capacity parameters; and
based on results of the comparison, destroying said file server or creating a child file server to thereby cull superfluous file servers from said network or provide additional file serving capacity respectively.

2. A method according to claim 1, wherein said resident program determines performance indicators of its file server, a parent of its file server and one or more child file servers of its file server at predetermined intervals.

3. A method according to claim 2, wherein a duration of the predetermined intervals is selected so that it is not too short to degrade performance of the file server and not too long to render the method ineffective.

4. A method according to claim 1, wherein the predetermined file server capacity parameters are stored in a data source accessible to the file servers via the electronic data network.

5. A method according to claim 4, wherein the file server capacity parameters include one or more of:
a CPU load parameter;
a file lock time parameter,
a poll cycle parameter, which stores a value for the duration of the predetermined intervals; and
a capacity limit parameter that determines the value at which the resident program is to deem its server to be full.

6. A method according to claim 5, wherein the data source comprises at least one database which maintains a file server table.

7. A method according to claim 4, wherein the data source relates identities of the file servers to a value indicating whether or not each file server is available for additional file storage.

8. A method according to claim 4, including a step of transmitting data identifying a created child server or a destroyed child server to the data source.

9. A method according to claim 4, wherein the resident program monitors file accesses occurring on the file server and transmits one or more data packets indicating quantity of the file accesses to the data source via the said network.

10. A method according to claim 7, wherein relationships of the file server to any parent file server and any child file servers thereof are maintained in the database.

11. A method according to claim 10, wherein the step of destroying the file server includes updating the relationships stored in the database so that child file servers of the to-be-destroyed file server are indicated to be children of the parent file server of the to-be-destroyed file server.

12. A method according to claim 10, wherein, if the to-be-destroyed file server does not have a parent file server then the first child of the to-be-destroyed file server may be indicated to become the parent of all remaining sibling file servers in the relationships stored in the database.

13. A method according to claim 7, including a step of maintaining a file table in the database wherein identifiers of files stored in said network of file servers are associated with the identifiers of file servers of the network.

14. A method according to claim 10, wherein the step of creating a child file server includes updating the relationships stored in the database to indicate a parent-to-child relationship between the file server and the child file server.

15. A method according to claim 14, wherein the method includes a step of transferring at least one file from the file to the newly created child file server subsequent to its creation to thereby bring performance indicators for available storage capacity of the file server below the predetermined capacity limit

16. A method according to claim 15, wherein the step of transferring at least one file comprises transferring every second file of the file server, in order of access frequency, to the newly created child file server and updating the database accordingly to correctly reflect the new location of said files.

17. A method according to claim 5, including a step of, where a CPU performance indicator is determined by the resident program to exceed the CPU load performance variable, sharing files with a quorum comprising at least one child and/or parent file servers.

18. A method according to claim 17, including polling file servers of said quorum to identify those file servers having most capacity to receive said shared files.

19. A method according to claim 7, including a step of maintaining a record in the database of files that have been duplicated.

20. A method according to claim 19, including, upon detecting duplicated files outside of the File-Lock Time frame parameter, deleting said files in order of eldest to youngest and updating corresponding file records in the database.

21. A plurality of file servers interconnected by an electronic data network, said file servers each being virtualization capable, wherein each of said file servers includes at least one processor in communication with an electronic memory device containing instructions for the at least one processors to:
determine performance indicators of the file server, including central processing unit load and available storage capacity;
compare performance indicators of the file server with predetermined file server capacity parameters; and
based on results of the comparison, destroying said file server or creating a child file server to thereby cull superfluous file servers or provide additional file serving capacity respectively.

22. A computer readable media bearing tangible machine readable instructions for a computer system to carry out the method of claim 1.
